(19) United States
(12) Patent Application Publication
(10) Pub. No.: US 2005/0274061 A1
(43) Pub. Date: Dec. 15, 2005

(54) Mosquito trapping device

(76) Inventor: Mantian Zhu, Oakton, VA (US)

Correspondence Address: MANTIAN ZHU, 11007 Langton Arms Court, Oakton, VA, 22124, US

(21) Appl. No.: 10/856,989

(22) Filed: Jun. 1, 2004

(51) Int. Cl. A01M 1/06; A01M 1/20

(52) U.S. Cl. 43/139; 43/107; 43/132.1

(57) ABSTRACT

The present invention relates to devices and methods for controlling mosquitoes and other biting insects. The devices and methods may reduce populations of adult mosquitoes and insects or reduce the number or eggs mosquitoes and insects may lay within the treated area. The devices may be used independently or in conjunction with other techniques, devices, or chemicals that may be useful in reducing mosquito or insect populations. The device may attract mosquitoes by generating heat, carbon dioxide, or water vapor, but also may lure mosquitoes to the trap by providing a pool or pools of standing water.

### FIELD OF THE INVENTION

The invention is generally directed toward devices and methods for controlling insects such as mosquitoes.

### BACKGROUND OF THE INVENTION

Mosquitoes and other insects are not only a nuisance and cause of discomfort, they are also known to carry a variety of diseases that can be harmful to people and pets. The Asian Tiger mosquito, for instance, has been identified as a potential carrier of the West Nile virus, which in recent years has seen outbreaks of the disease in several U.S. cities. In addition, mosquitoes are also known contributors to the transmission of Yellow Fever, Malaria, Encephalitis, and other vector-borne diseases.

One result of increases awareness of potential illnesses that mosquitoes can carry is that many cities, communities, and neighborhoods are taking steps to reduce the population of mosquitoes. For instance, attempts to control mosquito populations have included the use of pesticides to kill mature, adult mosquitoes and/or larvae.

The use of insecticide sprays and poisons can be effective to a significant degree, but relying on this approach alone can have several disadvantages. One disadvantage is that the cost of spraying can be high. Furthermore, the effect of treating an area with a pesticide may be short in duration. Once the poison's activity has dissipated, the insects are free to return to the area without harm. Thus, while the numbers of mosquitoes and other insects may be low immediately after spraying, more mosquitoes may appear soon after the pesticide is no longer active.

Yet another disadvantage to using pesticides is that their use may present risks to the people, pets, or other animals that live in or near the treated area. The poisons of some chemicals useful for killing insects and mosquitoes, for example, may be highly toxic and require people and pets to temporarily leave the treated area or remain indoors while it is being administered. It is more difficult, however, to take measures to ensure that local wildlife are protected from these more toxic chemicals if they are used.

In addition to having a possible detrimental effect on people, pets, and other animals, some pesticides also may be harmful to plants and flora in the treated area. While steps may be taken to cover or otherwise protect plant life, these measures can be time consuming and expensive. Repeated spraying of pesticides in a treated area also may have a propensity to build up toxic levels of poisons in the neighboring ecosystem.

Thus, while the use of pesticides can be helpful in combating mosquitoes and other insect populations, their use may not adequately solve insect or mosquito-related problems on their own without raising many health and environmental concerns. Thus, it is preferred that the pesticide use is moderated in some manner, such as by complementing its use with other methods for controlling insects and mosquitoes.

One such complementary approach is to alter the environment of the treated area to make is less hospitable to breeding. In particular, attempts to control mosquito populations frequently also include taking measures to reduce or eliminate resources or environments that are necessary or attractive to mosquitoes for breeding purposes. Thus, most mosquito control will include removing standing water from the treated area in order to make the area less attractive for laying eggs. The conventional wisdom is believed that by eliminating breeding areas the long-term population of mosquitoes will decline.

Another approach that may be used to help eliminate or reduce mosquito populations involves devices that may trap or kill adult mosquitoes. Some examples of these devices include those described in U.S. Pat. Nos. 5,205,064, 6,688,035, 5,669,176, and 6,145,243. In general, these devices attempt to mimic characteristics of a warm-blooded animal in order to attract mosquitoes and other biting insects into the trap. Typically, this is done by generating carbon dioxide, water vapor, and heat.

While these devices may be effective at mimicking a warm-blooded animal in order to attract and kill adult mosquitoes and other insects, conventional systems and devices typically do not provide any other features for attracting mosquitoes in other ways.

Conversely, one device, described in U.S. Pat. No. 6,708,443, which is incorporated herein in its entirety, is directed toward controlling mosquito populations by initially providing an attractive breeding area that does not kill any adult mosquitoes or insects but instead interrupts the development of laid eggs so that they do not mature or develop into mosquitoes. One disadvantage of this device, however, is that it essentially allows adult mosquitoes and other insects to continue to live in areas where people, pets, and other animals may also be living. Thus, this device does not aid in reducing populations of adult mosquitoes or insects that may be carriers for disease.

### SUMMARY OF THE INVENTION

The present invention is directed toward devices and methods for controlling mosquitoes and other insects in a designated area. In general, the devices and methods of the present invention are effective at reducing or eliminating adult mosquitoes and insects as well as reducing the number or eggs or larvae that mosquitoes and insects may lay within the treated area. The devices may be used independently or in conjunction with other techniques, devices, or chemicals that may be useful in reducing mosquito populations.

One embodiment of the present invention relates to an insect trapping apparatus that is capable of generating or providing a source of carbon dioxide for emission into the atmosphere, and has a heat source that is capable of generating heat up to the amount of heat generated by an adult human being. In addition to attracting mosquitoes to the trap by generating heat and carbon dioxide, the device also is capable of luring mosquitoes to the trap in yet another way.

In particular, the device is capable of luring mosquitoes to the trap by appearing to be a suitable environment for laying eggs. Thus, in one embodiment the device has a tray or receptacle that is capable of receiving fluid, such as water, and exposing the fluid to the atmosphere. A reservoir of fluid may also be provided with the device so that it may replenish or provide fluid to the tray or receptacle if the fluid level in the tray or receptacle falls below a predetermined level.

The device also has a trap for killing or holding the captured insects until their death. As mosquitoes approach the tray or receptacle of fluid, a vacuum or fan may draw the insects into the trap. Alternatively, a funnel or nozzle may be provided directly above the fluid exposed to the atmosphere. Once a mosquito deposits its eggs in or near the fluid, it will fly upwards into the funnel or nozzle so that the mosquito will be led into the trap.

In one embodiment of the invention, a canister of compressed gas, such as propane or the like, may be used as a source of carbon dioxide and heat. In some embodiments the compressed gas also may be used to generate water vapor. In another embodiment, a canister of compressed gas may be used as a source of carbon dioxide.

In another embodiment, the trap may be a mesh net operatively connected to the outlet of a vacuum or fan. Alternatively, the trap may be disposed before the vacuum or fan so that insects and mosquitoes become trapped prior to passing through an area where the vacuum or fan is operating.

The device also may have a self-contained power source. In other embodiment, the device may utilize electricity or other utilities from nearby structures or facilities in order to operate the device. In some embodiments, the device may be capable of generating some, and possibly all, of its own power.

In one embodiment, the device may have a rechargeable battery, while in another embodiment the device may utilize a solar power source, such as a solar panel, to at least partially provide any needed electricity or power for operating the device. In yet another embodiment, a catalytic converter may be operatively connected to a canister of compressed gas that may be used to at least partially supply power to the device.

In many embodiments, the device has an anchor base that is capable of supporting the various other components of the device. In one embodiment, the anchor base has an upper surface that is configured and adapted to have a recess. In this manner, the tray or receptacle used to hold the fluid may be integrally formed with the anchor base.

Alternatively, the anchor base may be configured in a similar manner as described above, but the tray or receptacle may be a liner that can be removed, cleaned, and returned to its position, or simply may be removed, discarded, and replaced with a new liner tray or receptacle. In embodiments where a liner tray or receptacle is used, a variety of different tray types may be provided so that the device may be easily reconfigured to attract different varieties of insects or mosquitoes.

Other embodiments of the invention relate to methods of attracting and trapping mosquitoes or other insects. One embodiment involves the steps of providing a source of carbon dioxide for emission to the atmosphere, providing a heat source capable of generating sufficient heat to approximate the heat generated and dissipated by an adult person, and providing a pool of standing fluid, such as water, to lure breeding mosquitoes closer to the trap.

Preferably, the carbon dioxide, heat, and standing fluid are capable of attracting closer to the designated area or trap mosquitoes or other insects seeking either warm-blooded animals to bite or a suitable place to lay their eggs. It is believed that the provision of standing water or similar fluid will increase the attraction for mosquitoes than is presently found in conventional approaches or devices.

As the mosquitoes or insects approach the designated area, a vacuum may be provided to force the mosquitoes into a trap where they may be killed or at least prevented from escaping.

In addition to devices that are capable of luring and trapping mosquitoes, some embodiments of the invention relate more generally toward methods for controlling mosquito or insect populations in a treated area. A treated area may be the yard of a home, a neighborhood, a farm, or the like. For example, an insecticide may be applied to an area of land surrounding the designated area where the trap is located.

The area of land within the treated area may be nearly any size, although as the size increases the number of traps provided may be increases. In one embodiment, the area of land is from about 0.03 acres to about 30 acres. In another embodiment, the area may be from about 0.5 acres to about 2 acres.

A variety of traps may be used in the devices or methods of the invention. In one embodiment, the trap may be a mesh net or screened cage or area where the mosquitoes and insects are prevented from escaping once inside. In one embodiment, the mesh net or screen may be periodically electrified to kill any insects trapped inside. Alternatively, the mosquitoes or other insects may simply dehydrate and die over time.

In yet another embodiment, the trap may comprise a killing field that kills the insects or mosquitoes once they enter into the field. The killing field may be made from a variety of devices or components. For example, the killing field may be made of a region or area having a high concentration of insecticide or poison sufficient to rapidly kill the insect or mosquito. In one embodiment, the pesticide or poison may periodically sprayed or administered to the killing field. In this embodiment, insects or mosquitoes may enter the killing field and temporarily remain alive inside. After a pesticide or poison is administered into the killing field, substantially all of the insects or mosquitoes trapped in the area will be killed.

In another embodiment, the killing field may comprise an electrified fence or screen that kills the insects or mosquitoes upon contact.

In yet another embodiment, the killing field may involve mechanical devices that crush or otherwise kill the insects or mosquitoes. For instance, the killing field may be formed from a plurality of rollers that rotate and crush the insects or mosquitoes. Alternatively, the killing field may have tacky or sticky surfaces, such as fly paper, that prevent an insect from escaping the killing field. As previously discussed in other embodiments, the killing field may also utilize more passive devices or structures. One example is the use of a screened cage or mesh net that simply prevents the insects from escaping.

Some methods of the invention may involve using a plurality of applications of insecticide or a plurality of devices or traps for killing the insects or mosquitoes. Thus, in one embodiment, an insecticide may be applied periodically, such as approximately once a month. Another embodiment involves using a second insecticide or poison to kill substantially all larvae in standing water on the area of land near the trap.

Additional features, advantages, and variations of the invention shall become apparent from the following detailed description and illustrative drawings.

### DESCRIPTION OF THE DRAWINGS

FIG. 1 is a side schematic view of an insect trapping apparatus of the present invention;

FIG. 2 is a top schematic view of an insect trapping apparatus of the present invention;

FIGS. 3A-C are top schematic and side views of one configuration of a water supply and multiple pools that cascade fluid from one pool to another;

FIGS. 4A-C are top schematic and side views of another configuration of a water supply and multiple pools that draw water from the water supply substantially independently from each other;

### DETAILED DESCRIPTION OF THE INVENTION

Referring now to the drawings, the present invention is directed toward devices and methods for reducing insects, particularly mosquitoes, by luring them into a trap with a device that mimics characteristics of a warm-blooded animal and also simulates an environment that may appear attractive to insects for breeding.

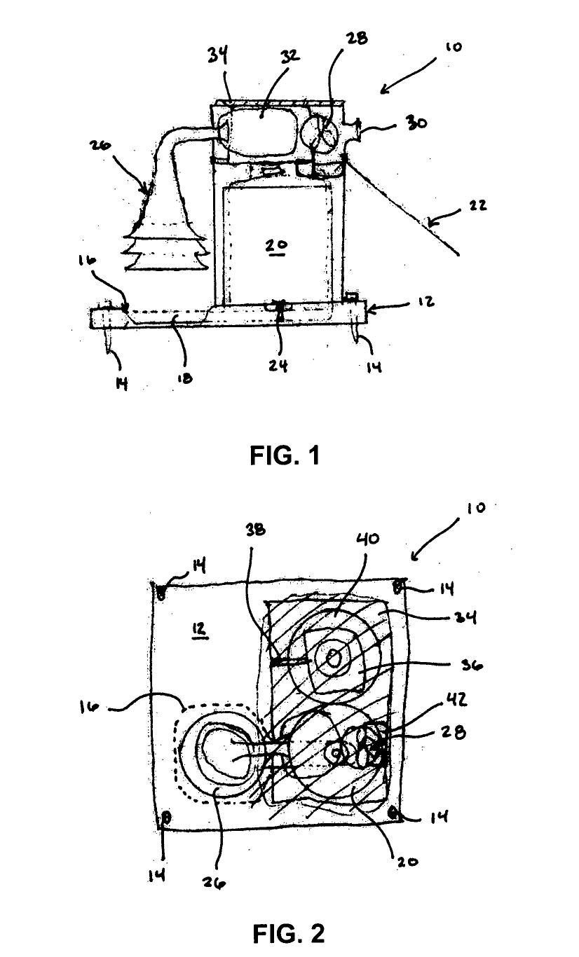

FIGS. 1 and 2 illustrate a non-limiting example of a device of the present invention. The device 10 comprises an anchor base 12 that is capable of supporting the various components of the system. If desired, anchors 14, such as nails, screws, or the like may be used to help secure the device to a base or foundation upon which the unit will be placed.

Turning to FIG. 1, the anchor base 12 may have a recess or tray 16 integrally formed therein for receiving a fluid of standing water 18 or the like for attracting mosquitoes looking to lay their eggs. If desired, a liner may be provided having an outer perimeter approximating the perimeter of the recess formed in the base 12. It is generally believed that different species of insects, including different species of mosquitoes, may be attracted to different types of breeding grounds. As a result, it may be desirable to provide a plurality of recesses 16 in either the anchor base 12 or in a liner that fits within the recess 16.

For instance, a separate liner tray may be used to form two distinct pools 18 of standing water. One pool of water 18 may be generally clean water that may be more attractive to certain species of mosquitoes. The second pool of water may include contaminants that simulate a pool of “dirty” water that may be more attractive to a different variety of mosquitoes or insects. Multiple water supplies may be provided to correspond to the number of different types of pools of standing fluid 18. More preferably, however, the liner and/or anchor base 12 are configured so that one source of water is capable of maintaining a desired fluid level for a plurality of pools.

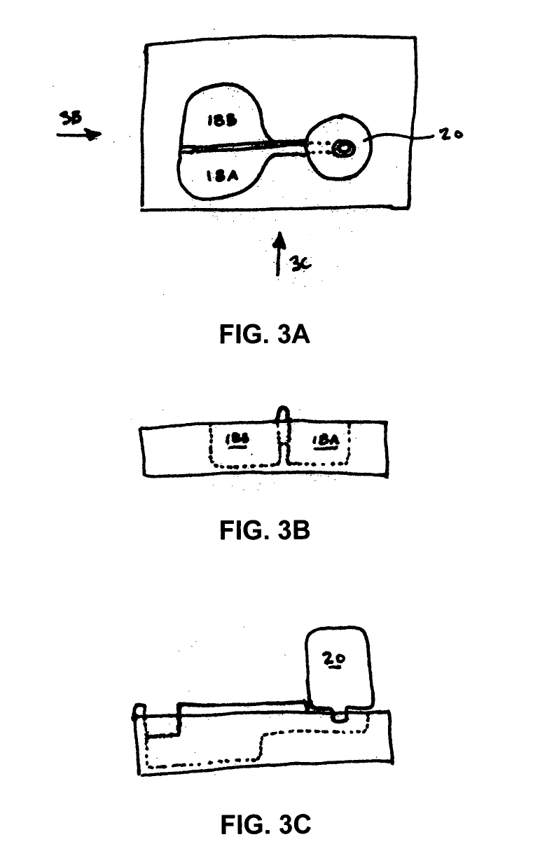

For instance, as illustrated in FIGS. 3A-C, water or other fluid supplied to the first pool 18A from a water source may then cascade over a ridge or partial wall to supply water or fluid 20 to another pool 18B. Preferably, the first pool of water 18A or fluid is “cleaner” in this embodiment than the second pool 18B so that water passing through the first pool to the second pool does not cause undesirable contamination of the second pool.

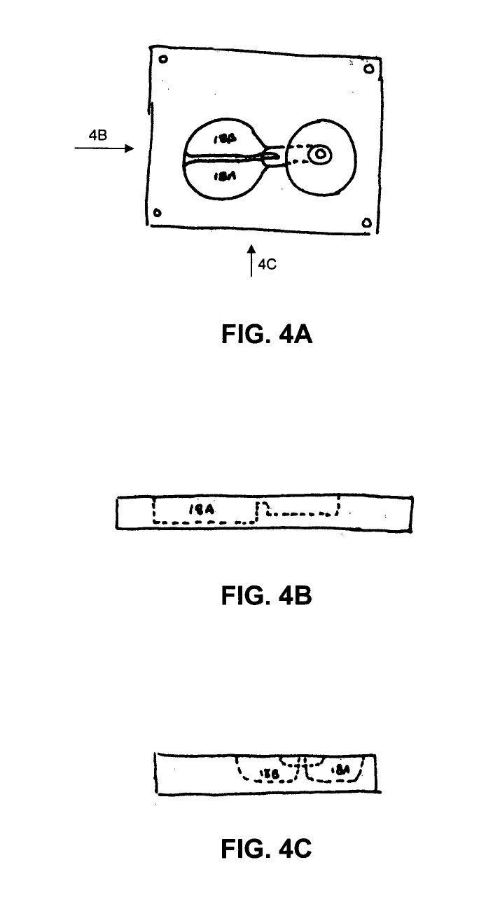

Alternatively, two or more separate channels or ducts may be configured to independently supply water to each of the pools without requiring the water or fluid to pass through and intermix with fluid from a first pool before reaching a second pool. In this manner, the potential for contaminants traveling between different pools of water or fluid can be reduced. This configuration is illustrated in FIGS. 4A-C. In particular, a supply of water 20 may be provided to a channel having a plurality of ridges or partial walls that allow the water from the channel to flow into each of the pools as water or fluid from the pools evaporates or otherwise is siphoned from the pools. In this manner, two or more pools may be maintained at desired fluid levels.

The water supply 20, may be a reservoir such as a bottle or similar container. The capacity of the water or fluid supply 20 may vary depending on the environmental conditions in which the device will be operating. Some factors that may determine the appropriate size of the water or fluid supply 20 include the temperature and humidity at which the device will operate, as well as the duration of operation before the reservoir or water supply may be refilled. Preferably, the water supply is capable of providing sufficient water or fluid to operate the device for at least two weeks without requiring the reservoir to be refilled. More preferably, the water supply is sufficient to operate for about 4 weeks or more.

Returning to FIG. 1, the water supply may have a downward facing opening or nozzle 24 that is configured to replenish fluid levels to the pools as needed or desired. Thus, when the fluid levels in the pools falls below a predetermined level, the opening or nozzle 24 of the water supply 20 is exposed to the surrounding atmosphere. When this happens, some water or fluid will be released from the container or reservoir and be replaced by a bubble of air. In essence, operation of the reservoir is much like the operation of a water cooler.

Since it is preferred that the device operate outdoors, a housing may be provided to protect many of the components of the device from the elements. A door 22 may provide access to the interior of the housing so that the components disposed inside may be readily maintained and replaced as needed.

As mentioned above, it is believed that providing one or more pools 18 of standing water or fluid will further help attract mosquitoes or other insects to the device so that they can be trapped and killed. It is also believed that shortly after mosquitoes deposit their eggs, they fly directly upwards to leave the area. Thus, it is desirable to place a suction hood 26 directly over the pool or pools of standing water in order to further ensure that the mosquitoes are caught and killed.

As shown in FIG. 1, the suction hood 26 may have a plurality of openings at varied heights so that it is able to draw in insects from a many different locations near the trap. A vacuum 28 draws air in through the openings of the suction hood 26 toward an exhaust 30. The vacuum may be a fan or a similar device capable of moving sufficient air to make it difficult, if not impossible for trapped insects to escape.

The moving air causes the insects or mosquitoes to be directed to a trap 32 that may be disposed between the vacuum 28 and the suction hood 26. Alternatively, the trap may be located downstream of the vacuum so that it is closer to, or perhaps part of, the exhaust 30.

The trap 32 may be constructed from a variety of structures. For example, it may be a mesh net, a screened cage, or the like. In some embodiments, the space or area around the trap may have a killing field that can rapidly kill insects trapped inside. This killing field may be provided either with chemical means, such as periodically spraying an insecticide. Alternatively, the killing field may be an electrified fence that is sufficiently charged to kill insects that contact it. Likewise, a screened cage that temporarily traps live insects may be periodically electrified to kill the insects trapped inside.

A fan 28 may be used to create a vacuum that causes air to flow through suction hood 26. The fan 28 may be capable of providing multiple speeds so that different air flow rates through the suction hood 26 can be established. The suction caused by the fan also may be useful in preventing trapped mosquitoes or other insects from escaping. Thus, once a mosquito is held within the trap, the flow of air entering into it may have a sufficient velocity to prevent mosquitoes from flying back out of the opening to the trap. In an alternative embodiment, the trap may be disposed on the exhaust side of the fan or vacuum.

The fan also may have other beneficial uses. For instance, the fan may be used to disperse the emission of carbon dioxide over a greater area than may be accomplished simply by releasing or generating it from a tank of compressed gas. In this manner, mosquitoes initially located further away from the device may be lured toward the trap. In addition, the fan also may be used to disperse generated heat and/or water vapor over a greater area. The fan may be configured to direct the dispersed CO₂, heat, and/or water vapor in a designated area or region. This configuration may be beneficial, for example, in preventing mosquitoes and other biting insects from entering or remaining in locations of a property where people will be located, such as a patio, a porch, or a play area for children. For example, the device may be configured to direct CO₂, heat, or water vapor around a perimeter of the outdoor area where people will be located. In addition, the exhaust may be used to emit or disperse an attractant, such as a cartridge of octenol. The type attractant, or use of one at all, may depend upon the type of mosquito or biting insect intended to be trapped.

The device may have a power supply to ensure its operation. Additionally, the catalytic converter may aid in powering the device by generating electricity. Other power sources also may be used to provide partial or full power to the unit. For example, the housing may have a solar panel disposed on it. In addition, a rechargeable battery may provide full or partial power to the unit. If needed, the unit may be configured to draw power from an external source, such as from an electrical outlet.

A compressed tank of gas may be provided with the unit. This tank of gas may be used to supply power, generate heat, water vapor, and/or CO₂. For example, the compressed gas in one embodiment is CO₂, while in another it is propane. The propane may undergo a catalytic process to generate any combination of CO₂, heat, water vapor, or electricity. The propane gas should be capable of allowing continuous operation for about 2 weeks or more, but preferably is sufficient to allow the unit to operate for about 4 weeks or more.

In addition to generating heat, water vapor, and/or CO₂ from a tank of compressed gas, the unit also may be configured with a pool of standing water to attract mosquitoes or other biting insects that lay eggs in water. The source of the water can be from a reservoir or it can be a by-product of the chemical reaction converting propane into head, CO₂, and water vapor. Water produced from the chemical reaction may drop into or otherwise be directed toward a reservoir. It is believed that providing standing water may increase the effectiveness of the trap over devices that do not provide standing water.

Standing water may be provided in a single pool disposed near or below the suction hood 26. Alternatively, multiple pools of water having different characteristics targeting or fitting different types of mosquitoes may be provided. FIGS. 3A-C and 4A-C illustrate various components and configurations that may be used to provide multiple pools of standing water to further attract a variety of different breeds of mosquitoes to the trap.

FIGS. 3A-C illustrate one embodiment where a first pool is maintained with fresh water from the reservoir to fit the environmental breeding preferences of Asian Tiger mosquitoes, while a second pool is maintained with environmental contaminants to fit the breeding habits of North American mosquitoes. As shown in FIGS. 3A-C, the pools may be configured so that water from the first pool can supply the second pool with minimal cross-contamination of the pools. The pools may be substantially separated from each other with a partition or dam. As the water level from the second pool is lowered, such as from evaporation, drainage, or the like, water from the first pool may enter the second pool through a portion of the partition or dam that is lower in height. This configuration will allow flow of water from the first pool to the second without permitting backflow or mixing that may be caused by turbulence when water from the reservoir is introduced to the first pool. Alternatively, each pool may have a separate reservoir. As shown in FIGS. 4A-C, the pools may be configured to each be supplied with water directly from the reservoir.

The size of the pools may also be engineered to further attract specific breeds of mosquitoes. For example, an Asian Tiger mosquito may be more likely attracted to a small pool of clean water, whereas a North American mosquito may be more attracted to large pools of dirty water. For example, the pool of clean water may have a surface area of up to 2 square inches, and preferably is about 0.5 square inches or less. Likewise, the dirty pool of water may have a surface area of about 10 square inches or greater. Thus, the pool of dirty water may be from about 5 to 20 times greater in size than the pool of clean water.

The device may be used on its own or may be part of an overall process to reduce mosquitoes and other biting insects from a designated area. For example, a designated area may be treated with an insecticide to initially reduce the population of adult mosquitoes in the area. The designated area may also be treated with an insecticide to kill mosquito larvae in standing water. The device described herein may then be placed on the property to attract and kill remaining mosquitoes, thereby further depleting the mosquito population in the area. The device may operate on a continuous basis, or may be selectively operated during selected times. For example, the device may only operate during times of the day when mosquitoes are feeding or breeding, such as in the evenings.

While several features and embodiments of the invention have been discussed in detail above, skilled artisans would recognize that many additional variations not explicitly discussed herein would also fall within the spirit and scope of the invention.

1. An insect trapping apparatus, comprising:
a source of carbon dioxide for emission into the atmosphere;
a heat source capable of generating sufficient heat to approximate the heat generated by a human being;
a tray capable of receiving a fluid and exposing the fluid to the atmosphere;
a reservoir of fluid capable of providing or replenishing fluid in the tray if the fluid level in the tray is below a predetermined level; and
a trap for holding captured insects until their death; and
a vacuum capable of drawing the insects into the trap.

2. The insect trapping apparatus of claim 1, wherein the source of carbon dioxide and heat comprises a canister of compressed gas.

3. The insect trapping apparatus of claim 2, wherein the canister of compressed gas is propane.

4. The insect trapping apparatus of claim 1, wherein the source of carbon dioxide is a canister of compressed CO₂.

5. The insect trapping apparatus of claim 1, wherein the vacuum comprises a fan, and wherein the trap comprises a mesh net operatively connected to the outlet of the vacuum.

6. The insect trapping apparatus of claim 2, further comprising a power source.

7. The insect trapping apparatus of claim 6, wherein the power source comprises a catalytic converter operatively connected to the canister of compressed gas.

8. The insect trapping apparatus of claim 6, wherein the power source comprises a solar panel.

9. The insect trapping apparatus of claim 2, wherein the canister of compressed gas is capable of generating water vapor.

10. The insect trapping apparatus of claim 1, further comprising an anchor base capable of supporting the apparatus, and wherein the tray forms a portion of the anchor base.

11. A method of attracting and trapping mosquitoes, comprising the steps of:
providing a source of carbon dioxide for emission into the atmosphere;
providing a heat source capable of generating sufficient heat to approximate the heat generated by a human being;
providing a pool of standing water, wherein the carbon dioxide, generate heat, and pool of standing water are capable of attracting mosquitoes to a designated area;
providing a vacuum to the designated area; and
vacuuming mosquitoes into a trap.

12. The method of claim 11, further comprising the step of:
applying a plurality of treatments of insecticide to an area of land surrounding the designated area.

13. The method of claim 12, wherein the area of land is from about 0.25 acres to about 3 acres.

14. The method of claim 13, wherein the area of land is from about 0.5 acres to about 2 acres.

15. The method of claim 11, wherein the trap comprises a mesh net that prevents mosquitoes from escaping.

16. The method of claim 15, further comprising the step of dehydrating the mosquitoes trapped in the net until their death.

17. The method of claim 11, wherein the step of providing a pool of standing water comprises:
providing a tray capable of receiving a fluid from a water reservoir or from the source of carbon dioxide and exposing the fluid to the atmosphere.

18. The method of claim 17, wherein the tray forms a portion of an anchor base that supports the source of carbon dioxide, heat source, vacuum, pool of standing water, and water reservoir.

19. The method of claim 17, further comprising providing a water reservoir capable of providing or replenishing water in the tray if the fluid level in the tray is below a predetermined level.

20. A method of reducing mosquitoes in a designated area, comprising the steps of:
applying a first treatment of a first insecticide to a designated area to kill substantially all of the mosquitoes in the area;
installing a mosquito trapping device, wherein the trapping device performs at least the steps of:
a) providing a source of carbon dioxide for emission into the atmosphere in the designated area;
b) providing a heat source capable of generating sufficient heat to approximate the heat generated by a human being;
c) providing a pool of standing water, wherein the carbon dioxide, generated heat, and pool of standing water are capable of attracting mosquitoes to the trapping device; and
d) vacuuming the mosquitoes into a trap; and
applying a second treatment of a second insecticide to the designated area.
